(19) United States
(12) Patent Application Publication
(10) Pub. No.: US 2021/0356090 A1
(43) Pub. Date: Nov. 18, 2021

(54) PROJECTION UNIT FOR LOW BEAM LIGHT OF VEHICLE AND VEHICLE LAMP USING SAME

(71) Applicant: HASCO VISION TECHNOLOGY CO., LTD., Shanghai (CN)

(72) Inventors: Jie ZHANG, Shanghai (CN); Shikun DONG, Shanghai (CN); Fan MENG, Shanghai (CN); Feiquan LI, Shanghai (CN); Jiayuan CHEN, Shanghai (CN)

(21) Appl. No.: 17/282,342

(22) PCT Filed: May 27, 2019
(86) PCT No.: PCT/CN2019/088531

§ 371 Date: Apr. 1, 2021

(30) Foreign Application Priority Data
Jul. 20, 2018 (CN) 201810804423.7
Jul. 20, 2018 (CN) 201821155929.1

(51) Int. Cl. F21S 41/148; F21S 41/32

(52) U.S. Cl. CPC F21S 41/148; F21W 2102/135; F21S 41/32

(57) ABSTRACT

Disclosed are a projection unit for a low beam light of a vehicle, and a vehicle lamp. The projection unit is composed of a light source, a reflection plate and an optical lens. Wherein the reflection plate is provided with a reflection boundary corresponding to the shape of a bright and dark cut-off line required by an illumination light shape of a vehicle lamp system, and the reflection plate is a plane reflector, a curved reflector, or a reflector formed by connecting multiple curved surfaces. The reflection boundary is arranged near a focus of the optical lens, the light source illuminates the reflection plate, and light rays reflected by the reflection plate form an initial illumination light shape.

### BACKGROUND OF THE INVENTION

### 1. Technical Field

The invention relates to the technical field of vehicle lamps, and particularly relates to a projection unit for a low beam light (dipped headlight) of a vehicle and a vehicle lamp using the same. The projection unit for a low beam light of a vehicle and the vehicle lamp using the same can realize the functions of vehicle lamps with the requirement for a (bright and dark) cut-off line such as low beam light and fog lamps, and can also realize the functions of vehicle lamps without the requirement for a cut-off line.

### 2. Description of Related Art

An existing projective vehicle lamp illumination system is typically composed of a light source 1, a reflector 2, a light shield plate 3 and an optical lens 4.

As shown in FIG. 1, the reflector 2 is generally a reflection surface like a parabolic surface and has a near focus and a far focus, the light source 1 is arranged at the near focus, Lambertian-like divergent light emitted by the light source 1 is reflected by the reflector 2 to be converged to the far focus of the reflector 2, the far focus is located near a focus of the optical lens 4, a light shield structure 3a of the light shield plate 3 is also arranged near the focus of the optical lens 4, the shape of the light shield structure 3a is determined according to the shape of a required bright and dark cut-off line, one part of light rays converged near to the focus of the optical lens 4 are shielded by the light shield structure 3a of the light shield plate 3 to form a dark area, and the rest of light rays penetrate through the lens 4 to be refracted onto a road surface to realize illumination. The light shield structure 3a of the light shield plate 3 is an important mechanism for forming a bright and dark cut-off line when a traditional projection unit is used as a low beam light.

However, the bifocal reflector like an ellipsoidal surface has a large depth, thus occupying a large space and being disadvantageous for a flat design of a vehicle lamp, which has great advantages and is becoming a development trend. The flat design can reduce the space occupied by the lamp, thus enlarging the volume of the trunk, transformed from an engine compartment, of new energy vehicles without an engine.

In addition, the existing projective vehicle lamp illumination system has too many parts, so that the assembly relationship of the parts is complicated; and the manufacturing errors of parts and the assembly of units lead to a great fluctuation in product performance. For example, the complaint of customers about inconsistent brightness of left and right lamps, and the manufacturing cost is relatively high.

In addition, the existing projective vehicle lamp illumination system is composed of too many parts (for example, the existing projective vehicle lamp illumination system is essentially provided with the reflector and the light shield plate), thus having the defects of a large weight, a complicated assembly relationship and large accumulative errors.

From the foregoing, the existing projective vehicle lamp illumination system has the following problems:

The light shield structure (bright and dark cut-off line) 3a of the light shield plate 3 reduces the luminous efficacy of the existing projective vehicle lamp illumination system;

The bifocal reflector like an ellipsoidal surface has a large depth, thus occupying a large space and being disadvantageous for a flat design of a vehicle lamp;

The existing projective vehicle lamp illumination system has too many parts, so that the assembly relationship of the parts is complicated; and the manufacturing errors of parts and the assembly of units lead to a large weight of the illumination system, a complicated assembly relation, large accumulative errors and a great fluctuation in product performance.

### BRIEF SUMMARY OF THE INVENTION

To solve the aforementioned problems, one objective of the invention is to provide a novel projection unit for a low beam light of a vehicle and a vehicle lamp using the same, which can meet the requirement for a bright and dark cut-off line, wherein the vehicle lamp has the functions of low beam lights and fog lamps, a flat design of the vehicle lamp is realized, and the specific structure, connection and arrangement of a light source, a reflection plate and an optical lens of the projection unit can replace a reflector and a light shield plate which are indispensable in the prior art.

Another objective of the invention is to provide a novel projection unit for a low beam light of a vehicle and a vehicle lamp using the same, which can realize the functions of vehicle lamps with the requirement for a bright and dark cut-off line such as low beam lights and fog lamps, as well as the functions of vehicle lamps without the requirement for a bright and dark cut-off line such as high beams, daytime running lamps, parking lamps, brake lamps, backup lamps and steering lamps. The specific structure, connection and arrangement of a light source, a reflection plate and an optical lens of the projection unit can replace a reflector and a light shield which are indispensible in the prior art, such that the size and space of the vehicle lamp are greatly reduced, and the fluctuation in product performance caused by manufacturing errors of parts and the assembly of units is reduced.

The technical solution of the projection unit for a low beam light of a vehicle provided by the invention is as follows:

The projection unit for a low beam light of a vehicle comprises a light source and an optical lens in an emergent direction of a low beam light, wherein:

A reflection plate is arranged in the direction of an optical axis of the light source, and light rays reflected by the reflection plate illuminate a road surface through the optical lens;

The reflection plate is provided with a reflection boundary corresponding to the shape of a bright and dark cut-off line required by an illumination light shape of a vehicle lamp system to replace a light shield plate and a boundary of the light shield plate, and the reflection boundary of the reflection plate is arranged at or near a focus of the optical lens;

The light source illuminates the reflection plate, the light rays reflected by the reflection plate form an initial illumination light shape and then illuminate the road surface through the optical lens to form a final secondary light shape with a bright and dark cut-off line.

According to the light-emitting characteristic of the light source, the curvature of the reflection surface is set to control the light intensity distribution of the secondary illumination light shape to make the secondary light illumination shape close to an inflection point of the bright and dark cut-off line, such that the light intensity of the secondary illumination light shape is increased.

The projection unit for a low beam light of a vehicle of the invention is characterized in that:

The light source is preferably a surface light source, and is further preferably an LED.

The projection unit for a low beam light of a vehicle is characterized in that:

A reflection surface of the reflection plate is arc, and the reflection boundary of the reflection plate is located at an upper end of the reflection plate.

The projection unit for a low beam light of a vehicle of the invention is characterized in that:

A reflection surface of the reflection plate is arc, and the reflection boundary of the reflection plate is located at a lower end of the reflection plate (as shown in FIG. 11, FIG. 12 and FIG. 13).

The projection unit for a low beam light of a vehicle of the invention is characterized in that:

The reflection boundary of the reflection plate is arranged 0-5 mm away from a focus of the lens.

The projection unit for a low beam light of a vehicle of the invention is characterized in that:

Light rays reflected by the reflection boundary of the reflection plate enter an incident plane of the lens approximately horizontally.

The projection unit for a low beam light of a vehicle of the invention is characterized in that:

The reflection plate has a reflectivity not less than 80%.

The projection unit for a low beam light of a vehicle of the invention is characterized in that:

A material surface of the reflection plate is treated to realize the reflectivity, for example, the material surface is coated with aluminum.

The projection unit for a low beam light of a vehicle of the invention is characterized in that:

A secondary light distribution member is additionally arranged between the light source and the reflection plate to converge the light rays or change the light energy distribution to improve the luminous efficacy.

The projection unit for a low beam light of a vehicle of the invention is characterized in that:

The reflection plate is a plane reflector, a curved reflector, or a reflector formed by connecting multiple curved surfaces.

The projection unit for a low beam light of a vehicle of the invention is characterized in that:

The secondary light distribution member arranged between the light source and the reflection plate is a convex lens, a transparent photoconductor, or a reflector.

As shown in FIG. 7 and FIG. 8, the secondary light distribution member arranged between the light source and the reflection plate is a convex lens for increasing the light intensity. Or, as shown in FIG. 10, the secondary light distribution member arranged between the light source and the reflection plate is a reflector for improving the luminous efficacy.

A vehicle light comprising the projection unit for a low beam light of a vehicle mentioned above.

According to the invention, the specific structure, connection and arrangement of the light source, the reflection plate and the optical lens of the projection unit can replace a reflector and a light shield which are indispensable in the prior art, such that the size and space of the vehicle lamp are greatly reduced, and the fluctuation in product performance caused by manufacturing errors of parts and the assembly of units is reduced.

According to the invention, the specific structure, connection and arrangement of the light source, the reflection plate and the optical lens of the projection unit can replace a reflector and a light shield which are indispensable in the prior art, such that the vehicle lamp has the functions of low beam lights and fog lamps, the size and space of the vehicle lamp are greatly reduced, and a flat design of the vehicle lamp is realized. In addition, the specific structure, connection and arrangement of the light source, the reflection plate and the optical lens of the projection unit can replace the reflector and the light shield which are indispensable in the prior art, and the fluctuation in product performance caused by manufacturing errors of parts and the assembly of units is reduced.

### BRIEF DESCRIPTION OF THE SEVERAL VIEWS OF THE DRAWINGS

FIG. 1 is a structural diagram of a traditional projection unit for a vehicle lamp;

FIG. 2 is a light-emitting diagram of the traditional projection unit for a vehicle lamp;

FIG. 3A is a schematic diagram of the light path of a projection unit for a low beam light of a vehicle according to the invention;

FIG. 3B is a front view of one side of a lens of the projection unit for a low beam light of a vehicle according to the invention;

FIG. 4 is a schematic diagram of a low beam path of the projection unit for a low beam light of a vehicle according to the invention;

FIG. 5 is a schematic diagram of a dipped-beam illumination path of the projection unit for a low beam light of a vehicle according to the invention;

FIG. 6A is a schematic diagram of the set state of a reflection plate of the projection unit for a low beam light of a vehicle according to the invention;

FIG. 6B is a left view of the reflection plate, shown in FIG. 6A, of the projection unit for a low beam light of a vehicle according to the invention;

FIG. 6C is a top view of a reflection surface of the reflection plate, shown in FIG. 6A, of the projection unit for a low beam light of a vehicle according to the invention;

FIG. 7A is a schematic diagram of the projection unit for a low beam light of a vehicle with a secondary light distribution member additionally arranged between a light source and a reflection plate according to the invention;

FIG. 7B is a front view of one side of a lens of the projection unit for a low beam light of a vehicle shown in FIG. 7A;

FIG. 7C is a left view of the projection unit for a low beam light of a vehicle shown in FIG. 7B;

FIG. 8 is a schematic diagram of a light path of the projection unit for a low beam light of a vehicle with the secondary light distribution member additionally arranged between the light source and the reflection plate, shown in FIG. 7A;

FIG. 9A is another schematic diagram of the projection unit for a low beam light of a vehicle with the secondary light distribution member additionally arranged between the light source and the reflection plate according to the invention;

FIG. 9B is a front view of one side of a lens of the projection unit for a low beam light of a vehicle, shown in FIG. 9A;

FIG. 9C is a left view of the projection unit for a low beam light of a vehicle, shown in FIG. 9B;

FIG. 10 is the schematic diagram of another light path of the projection unit for a low beam light of a vehicle with the secondary light distribution member additionally arranged between the light source and the reflection plate, shown in FIG. 9A;

FIG. 11 is a schematic diagram of a reflection boundary at a lower end of the reflection plate;

FIG. 12 is the schematic diagram of the light path in case where the reflection boundary is located at the lower end of the reflection plate;

FIG. 13A is the front view of the reflection boundary at the lower end of the reflection plate.

FIG. 13B is the left view of the reflection boundary at the lower end of the reflection plate.

FIG. 13C is the top view of the reflection boundary at the lower end of the reflection plate.

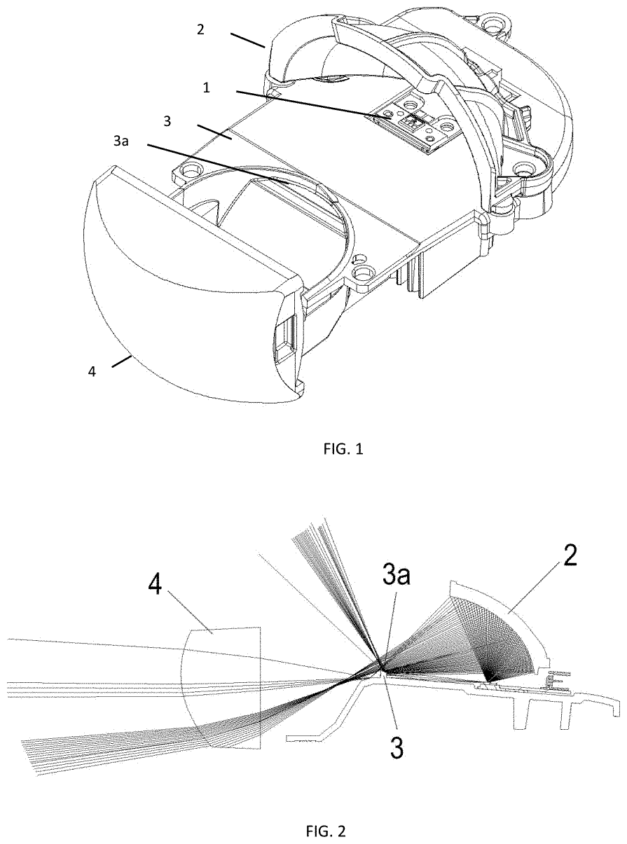

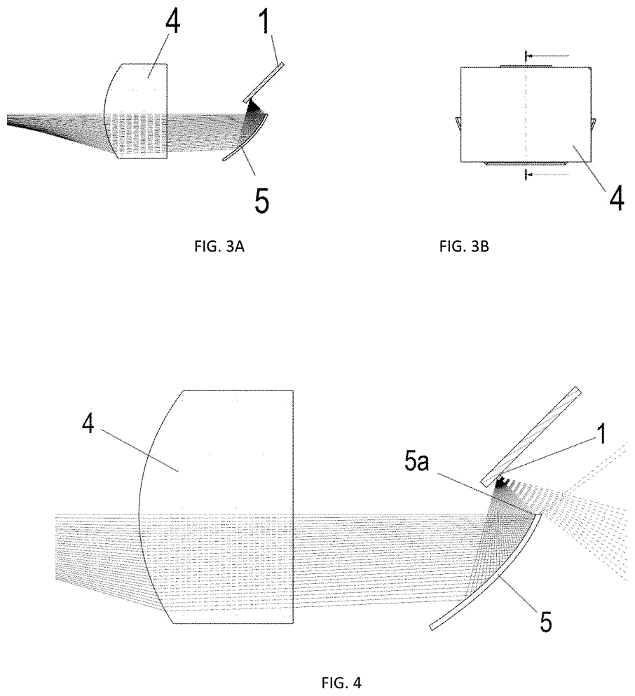

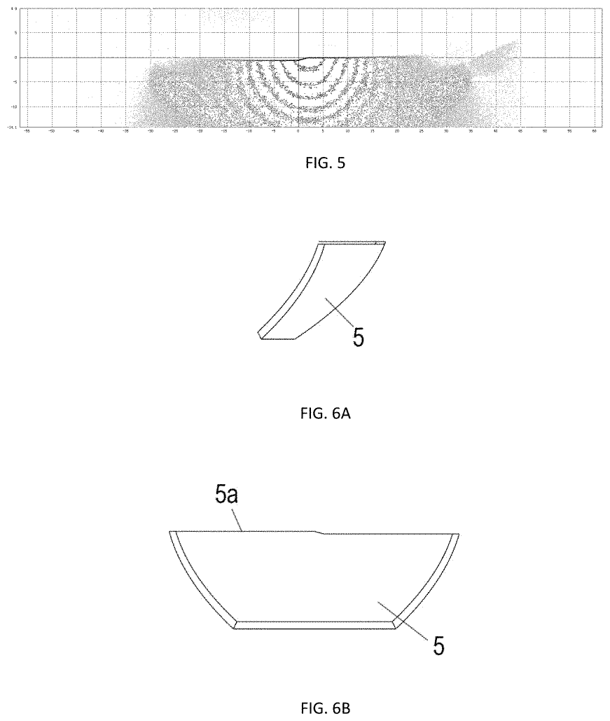

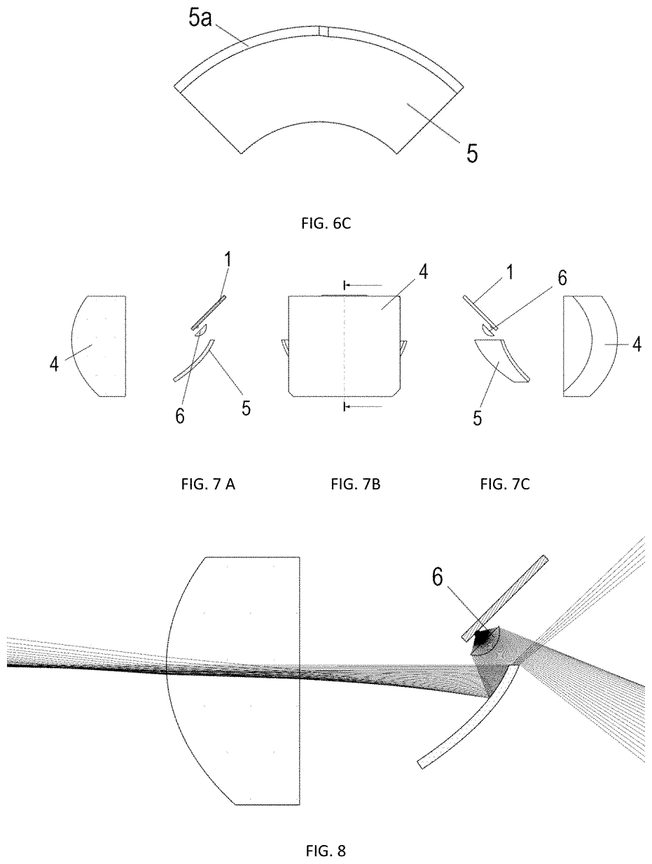

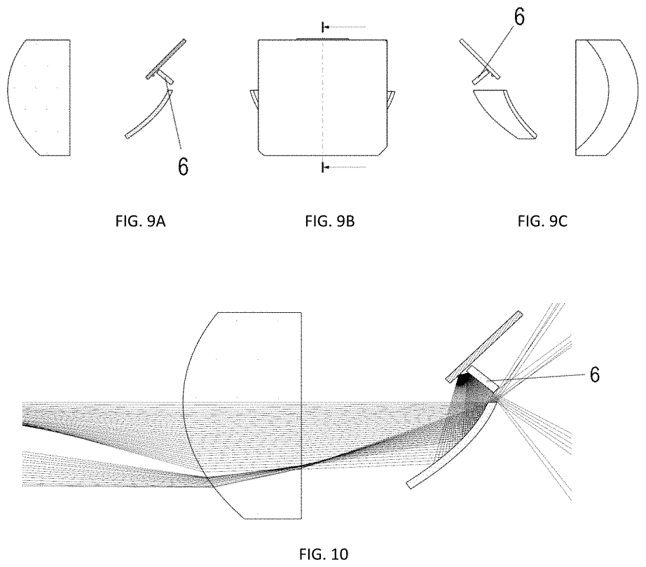

In the figures: 1, LED light-emitting chip circuit board; 2, reflector; 3, light shield plate; 3a, cut-off line of light shield plate; 4, optical lens; 5, reflection plate; 5a, bright and dark cut-off line of reflection boundary of reflection plate; 6, secondary light distribution lens;

The reflection boundary of the reflection plate corresponds to the shape of a bright and dark cut-off line required by an illumination light shape of a vehicle lamp system.

### DETAILED DESCRIPTION OF THE INVENTION

The invention will be explained in further detail below in conjunction with the accompanying drawings and specific embodiments.

### Embodiment 1

A projection unit for a low beam light of a vehicle comprises a light source and an optical lens, and is provided with a reflection plate, wherein an upper boundary of the reflection plate is provided with a boundary corresponding to the shape of a bright and dark cut-off line required by an illumination light shape of a vehicle lamp system to replace a light shield plate and a boundary of the light shield plate, and the reflection boundary of the reflection plate is arranged near a focus of the optical lens. The light source is an LED surface light source. The light source illuminates the reflection plate, and light rays reflected by the reflection plate form an initial illumination light shape and then illuminate a road surface through the optical lens to form a final illumination light shape with a bright and dark cut-off line.

An optical axis of the light source of the projection unit deviates from the normal of the reflection plate by 45°, the reflection plate is arranged below the light source at an angle of 45°, a reflection surface of the reflection plate is arc, and the material surface of the reflection plate is coated with aluminum to realize a reflectivity not less than 50%. The reflection boundary of the reflection plate is located at the upper end of the reflection plate, and the optical axis of the light source of the projection unit is parallel to the normal of the reflection plate. The light rays reflected by the reflection plate illuminate the road surface in parallel with an optical axis of the optical lens.

According to the light-emitting characteristic of the light source, the curvature of the reflection surface is set to control the light intensity distribution of a secondary illumination light shape to make the secondary light illumination shape close to an inflection point of the bright and dark cut-off line, such that the light intensity of the secondary illumination light shape is increased.

According to this embodiment, the light source illuminates the reflection plate, and the light rays reflected by the reflection plate form the initial illumination light shape and then illuminate the road surface through the optical lens to form the final illumination light shape with the bright and dark cut-off line.

### Embodiment 2

This embodiment is identical with Embodiment 1 except in the following aspect:

A secondary light distribution member is additionally arranged between the light source and the reflection plate. The secondary light distribution member is a convex lens or a reflector, and is used for converging the light rays or changing the light energy distribution to improve the luminous efficacy.

### Embodiment 3

This embodiment is identical with Embodiment 1 except in the following aspect:

The reflection boundary of the reflection plate is arranged 0-5 mm away from the focus of the lens.

### Embodiment 4

This embodiment is identical with Embodiment 1 except in the following aspect:

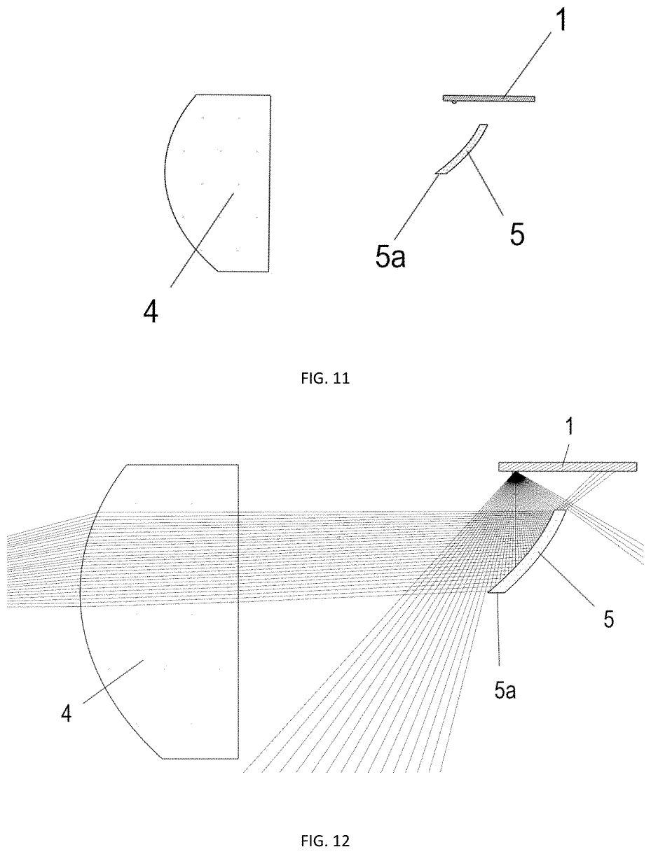

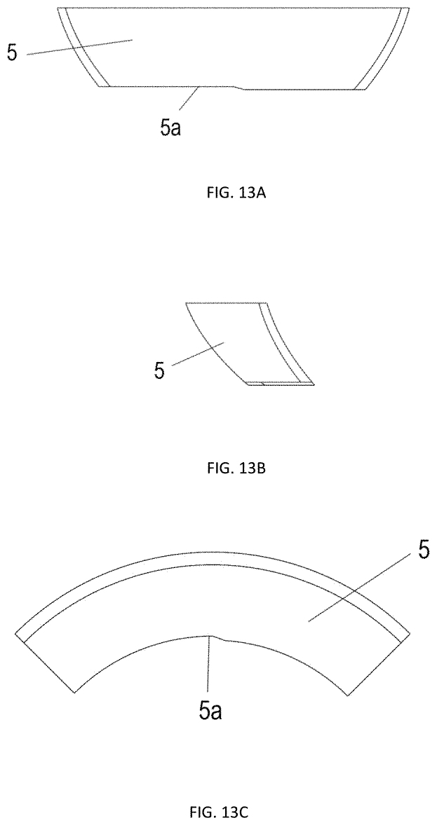

The reflection boundary of the reflection plate is located at the lower end of the reflection plate, as shown in FIG. 11, FIG. 12 and FIG. 13.

According to the invention, the specific structure, connection and arrangement of the light source, the reflection plate and the optical lens of the projection unit can replace a reflector and a light shield which are indispensable in the prior art, such that the vehicle lamp has the functions of low beam lights and fog lamps, the size and space of the vehicle lamp are greatly reduced, and a flat design of the vehicle lamp is realized. In addition, the specific structure, connection and arrangement of the light source, the reflection plate and the optical lens of the projection unit can replace the reflector and the light shield which are indispensable in the prior art, and the fluctuation in product performance caused by manufacturing errors of parts and the assembly of units is reduced.

What is claimed is:

1. A projection unit for a low beam light of a vehicle, comprising a light source and an optical lens in an emergent direction of a low beam light, wherein:
a reflection plate is arranged in the direction of an optical axis of the light source, and light rays reflected by the reflection plate illuminate a road surface through the optical lens;
the reflection plate is provided with a reflection boundary corresponding to a shape of a bright and dark cut-off line required by an illumination light shape of a vehicle lamp system to replace a light shield plate and a boundary of the light shield plate, and the reflection boundary of the reflection plate is arranged at or near a focus of the optical lens;
the light source illuminates the reflection plate, the light rays reflected by the reflection plate form an initial illumination light shape and then illuminate the road surface through the optical lens to form a final secondary light shape with a bright and dark cut-off line.

2. The projection unit for a low beam light of a vehicle according to claim 1, wherein:
the light source is preferably a surface light source, and is further preferably an LED.

3. The projection unit for a low beam light of a vehicle according to claim 1, wherein:
a reflection surface of the reflection plate is arc, and the reflection boundary of the reflection plate is located at an upper end of the reflection plate.

4. The projection unit for a low beam light of a vehicle according to claim 1, wherein:
a reflection surface of the reflection plate is arc, and the reflection boundary of the reflection plate is located at a lower end of the reflection plate.

5. The projection unit for a low beam light of a vehicle according to claim 1, wherein:
the reflection boundary of the reflection plate is arranged 0-5 mm away from a focus of the lens.

6. The projection unit for a low beam light of a vehicle according to claim 1, wherein:
light rays reflected by the reflection boundary of the reflection plate enter an incident plane of the lens approximately horizontally.

7. The projection unit for a low beam light of a vehicle according to claim 1, wherein:
the reflection plate has a reflectivity not less than 80%.

8. The projection unit for a low beam light of a vehicle according to claim 1, wherein:
a secondary light distribution member is additionally arranged between the light source and the reflection plate to converge the light rays or change a light energy distribution to improve luminous efficacy.

9. The projection unit for a low beam light of a vehicle according to claim 1, wherein:
the reflection plate is a plane reflector, a curved reflector, or a reflector formed by connecting multiple curved surfaces.

10. The projection unit for a low beam light of a vehicle according to claim 8, wherein:
the secondary light distribution member arranged between the light source and the reflection plate is a convex lens, a transparent photoconductor, or a reflector.

11. A vehicle lamp, using the projection unit for a low beam light of a vehicle according to claim 1.
